(19) United States
(12) Patent Application Publication
(10) Pub. No.: US 2018/0183932 A1
(43) Pub. Date: Jun. 28, 2018

(54) METHOD AND APPARATUS FOR CALL FORWARDING, TERMINAL AND NETWORK SIDE DEVICE

(71) Applicant: SPREADTRUM COMMUNICATIONS (SHANGHAI) CO., LTD., Zhangjiang (CN)

(72) Inventors: Xichun GAO, Zhangjiang (CN); Xianliang CHEN, Zhangjiang (CN); Yiguo ZHAO, Zhangjiang (CN); Yi HE, Zhangjiang (CN)

(21) Appl. No.: 15/800,631

(22) Filed: Nov. 1, 2017

(30) Foreign Application Priority Data
Dec. 22, 2016 (CN) 201611199662.1

(51) Int. Cl. H04M 3/54

(52) U.S. Cl. CPC H04M 3/54

(57) ABSTRACT

A method and an apparatus for call forwarding, a terminal and a network side device are provided in the present disclosure. The method includes: receiving a call request; receiving a call forwarding request made by a user, where a call forwarding destination number is carried in the call forwarding request; and transmitting a response message containing the call forwarding destination number to a network side, so that the network side can forward the call request to a terminal corresponding to the call forwarding destination number according to the response message. The method and the apparatus in the present disclosure can forward an incoming call to any number selected by a user in real time and improve flexibility of call forwarding.

### CROSS-REFERENCE TO RELATED APPLICATIONS

The present invention claims priority under 35 U.S.C. § 119 to Chinese Patent Application No. 201611199662.1 filed on Dec. 22, 2016, the entire content of which is incorporated herein by reference.

### TECHNICAL FIELD

The present disclosure relates to a communication technology field, and more particularly, to a method and an apparatus for call forwarding, a terminal and a network side device.

### BACKGROUND

With development of communication technology, functions of communication terminals become enriched gradually, and user demands for telephone service become more and more diversified, for example, a user demand for call forwarding service. The conventional call forwarding function is achieved by configuring a network with a call forwarding destination number, when the call forwarding function is triggered, the network will forward a call to the call forwarding destination number.

The inventors have found that there are at least the following technical problems in a conventional technology.

The existing method for call forwarding requires configuring a fixed dialing number in advance and cannot change the call forwarding destination flexibly.

### SUMMARY

A method and an apparatus for call forwarding, a terminal and a network side device provided in the present disclosure can forward an incoming call to any number selected by a user in real time and improve flexibility of call forwarding.

A method for call forwarding is provided in the present disclosure. The method includes: receiving a call request; receiving a call forwarding request made by a user, where a call forwarding destination number is carried in the call forwarding request; and transmitting a response message containing the call forwarding destination number to a network side, so that the network side can forward the call request to a terminal corresponding to the call forwarding destination number according to the response message.

Optionally, the call forwarding destination number includes a number input by the user or a number corresponding to a contact selected by the user.

Optionally, the response message includes information indicating forwarding.

A method for call forwarding, applied to a network side device, is provided in the present disclosure. The method includes: receiving a response message containing a call forwarding destination number; and forwarding a call request to a terminal corresponding to the call forwarding destination number according to the response message.

Optionally, the method further includes transmitting a notification message of forwarding the call request to the call forwarding destination number to a calling party terminal, after receiving the response message containing the calling forwarding destination number.

An apparatus for call forwarding located in a called party terminal is provided according to embodiments of the present disclosure. The apparatus includes a first receiving circuitry, configured to receive a call request; a second receiving circuitry, configured to receive a call forwarding request made by a user, where a call forwarding destination number is carried in the call forwarding request; and a first transmitting circuitry, configured to transmit a response message containing the call forwarding destination number to a network side, so that the network side can forward the call request to a terminal corresponding to the call forwarding destination number according to the response message.

Optionally, the call forwarding destination number includes a number input by the user or a number corresponding to a contact selected by the user.

Optionally, the response message includes information indicating forwarding.

An apparatus for call forwarding located in a network side device is provided according to embodiments of the present disclosure. The apparatus includes a third receiving circuitry, configured to receive a response message containing a call forwarding destination number; and a forwarding circuitry, configured to forward a call request to a terminal corresponding to the call forwarding destination number according to the response message.

Optionally, the apparatus includes a second transmitting circuitry, configured to transmit a notification message of forwarding the call request to the call forwarding destination number to a calling party terminal, after the third receiving circuitry receives the response message containing the calling forwarding destination number.

A terminal is provided in the present disclosure, where the terminal includes the aforementioned apparatus for call forwarding located in the called party terminal.

A network side device is provided in the present disclosure, where the network side device includes the aforementioned apparatus for call forwarding located in the network side device.

The method and the apparatus for call forwarding, the terminal and the network side device provided according to embodiments of the present disclosure can forward an incoming call to any number selected by a user in real time by transmitting the call forwarding destination number selected by the user to the network side. Compared with the conventional technology, flexibility of call forwarding can be improved in the present disclosure.

### BRIEF DESCRIPTION OF THE DRAWINGS

FIG. 1 schematically illustrates a flow chart of a method for call forwarding according to an embodiment of the present disclosure;

FIG. 2 schematically illustrates a flow chart of a method for call forwarding according to another embodiment of the present disclosure;

FIG. 3 schematically illustrates a structural diagram of an apparatus for call forwarding according to an embodiment of the present disclosure;

FIG. 4 schematically illustrates a structural diagram of an apparatus for call forwarding according to another embodiment of the present disclosure; and

FIG. 5 schematically illustrates a structural diagram of an apparatus for call forwarding according to another embodiment of the present disclosure.

### DETAILED DESCRIPTION

In order to make the above-mentioned objects, features and advantages of the present disclosure more easily understood, specific embodiments of the present disclosure will be described in detail with reference to the accompanying drawings below. Apparently, embodiments described below are merely a portion of embodiments of the present disclosure, and are not all embodiments. All other embodiments obtained by those of ordinary skill in the art without making creative work are within the scope of the present disclosure, based on embodiments disclosed hereinafter.

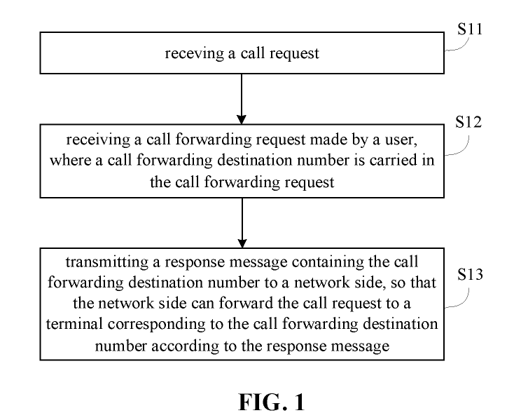

A method for call forwarding applied to a called party terminal is provided in the present disclosure. Referring to FIG. 1, the method includes S11, S12 and S13.

In S11, a call request is received.

In S12, a call forwarding request made by a user is received, where a call forwarding destination number is carried in the call forwarding request.

In S13, a response message containing the call forwarding destination number is transmitted to a network side, so that the network side can forward the call request to a terminal corresponding to the call forwarding destination number according to the response message.

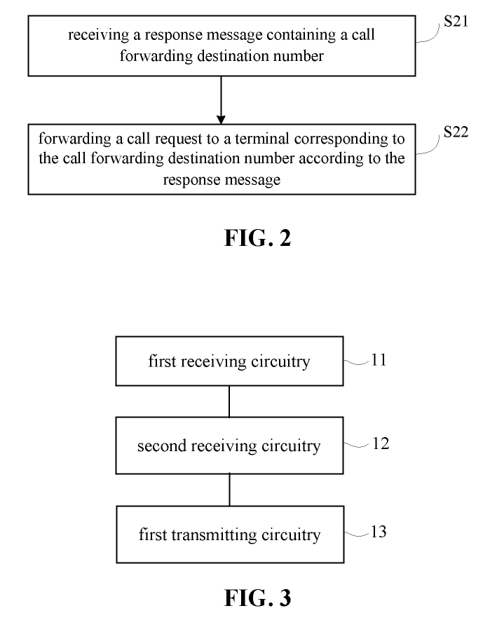

A method for call forwarding, applied to a network side device, is provided according to embodiments of the present disclosure. Referring to FIG. 2, the method includes S21 and S22.

In S21, a response message containing a call forwarding destination number is received.

In S22, a call request is forwarded to a terminal corresponding to the call forwarding destination number according to the response message.

The method for the call forwarding in the present disclosure will be described below in specific embodiments.

In some embodiments, a calling party terminal B transmits a call request to a called party terminal A, regardless of the called party terminal A is in an idle state or in a call state, if a user of the terminal A chooses to forward the call request to a user of a terminal C, the terminal A may enter a number of the terminal C or select the number of the terminal C from contacts, and click a forwarding button on an interface, then a signaling will be send to a network, where the signal contains the number of the terminal C and a message indicating forwarding.

Specifically, the terminal A may send a 486 signaling to a network. In the 486 signaling, the following header fields are also carried in addition to the basic header fields.

History-info: A number; C number Reason:

sip; text=“call is being forwarded”

The History-info header field indicates to the network that the terminal A requires forwarding the current call request to the terminal C. The Reason header field carries information indicating forwarding, where the signaling in which the terminal A notifies the network of call forwarding is not limited to the 486 signaling, and the header fields are also not limited to the History-info head field and the Reason header field, and may be any signaling or header field that can indicate to the network that the call needs to be forwarded.

After receiving the 486 signaling from the terminal A, the network detects a cause value of “call is being forwarded” in the Reason header field, and determines that the call needs to be forwarded; and further acquires the number of the terminal C to be forwarded to from the History-info header field. Then the network forwards the call request sent by the terminal B to the terminal C and transmits a 181 signaling to inform the terminal B that the call is forwarded to the terminal C.

The method for call forwarding provided according to the embodiments of the present disclosure can forward the incoming call to any number selected by the user in real time by transmitting the call forwarding destination number selected by the user to the network side. Compared with the conventional technology, flexibility of call forwarding can be improved in the present disclosure.

An apparatus for call forwarding, located in a called party terminal is also provided according to embodiments of the present disclosure.

Referring to FIG. 3, the apparatus includes: a first receiving circuitry 11, configured to receive a call request; a second receiving circuitry 12, configured to receive a call forwarding request made by a user, where a call forwarding destination number is carried in the call forwarding request; and a first transmitting circuitry 13, configured to transmit a response message containing the call forwarding destination number to a network side, so that the network side can forward the call request to a terminal corresponding to the call forwarding destination number according to the response message.

In some embodiments, the call forwarding destination number may include a number input by the user or a number corresponding to a contact selected by the user.

In some embodiments, the response message includes information indicating forwarding.

An apparatus for call forwarding, located in a network side device, is also provided according to embodiments of the present disclosure.

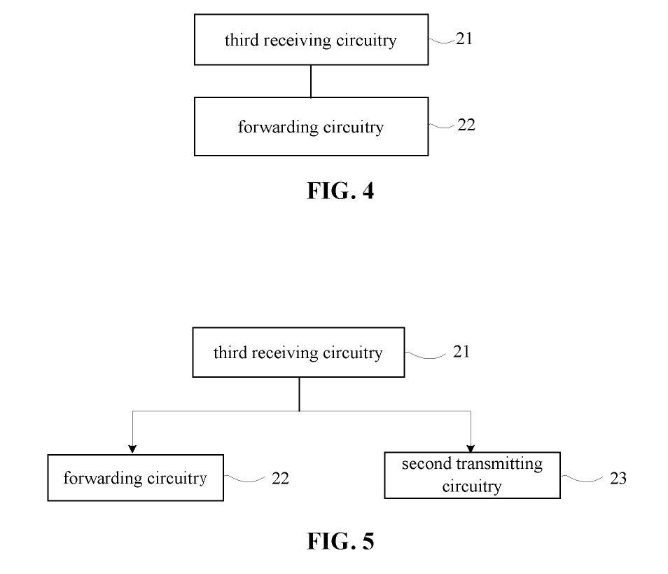

Referring to FIG. 4, the apparatus includes a third receiving circuitry 21, configured to receive a response message containing a call forwarding destination number; and a forwarding circuitry 22, configured to forward a call request to a terminal corresponding to the call forwarding destination number according to the response message.

Referring to FIG. 5, in some embodiments, the apparatus for call forwarding may further include a second transmitting circuitry 23, configured to transmit a notification message of forwarding the call request to the call forwarding destination number to a calling party terminal, after the third receiving circuitry 21 receives the response message containing the calling forwarding destination number.

The apparatus for call forwarding provided according to the embodiments of the present disclosure can forward the incoming call to any number selected by the user in real time by transmitting the call forwarding destination number selected by the user to the network side. Compared with the conventional technology, flexibility of call forwarding can be improved in the present disclosure.

A terminal is also provided according to embodiments of the present disclosure, where the terminal includes the aforementioned apparatus for call forwarding located in the called party terminal.

A network side device is also provided according to the embodiments of the present disclosure, where the network side device includes the aforementioned apparatus for call forwarding located in the network side device.

It will be appreciated by those of ordinary skill in the art that all or a portion of the steps in the various methods of the embodiments described above may be performed by a program that instructs the associated hardware to be stored in a computer-readable storage medium which may include: ROM, RAM, magnetic disk, or optical disk.

Although the present disclosure has been described above, the present disclosure is not limited thereto. It should be understood by those skilled in the art that various changes and modifications may be made without departing from the spirit and scope of the disclosure, and therefore, the scope of the disclosure should be limited by the scope of the claims.

1. A method for call forwarding, comprising:
receiving a call request;
receiving a call forwarding request made by a user, where a call forwarding destination number is carried in the call forwarding request; and
transmitting a response message containing the call forwarding destination number to a network side, so that the network side can forward the call request to a terminal corresponding to the call forwarding destination number according to the response message.

2. The method according to claim 1, wherein the call forwarding destination number comprises a number input by the user or a number corresponding to a contact selected by the user.

3. The method according to claim 1, wherein the response message comprises information indicating forwarding.

4. A method for call forwarding, adapted to a network side equipment, comprising:
receiving a response message containing a call forwarding destination number; and
forwarding a call request to a terminal corresponding to the call forwarding destination number according to the response message.

5. The method according to claim 4, further comprising:
transmitting a notification message of forwarding the call request to the call forwarding destination number to a calling party terminal, after receiving the response message containing the calling forwarding destination number.

6. An apparatus for call forwarding, located in a called party terminal, comprising:
a first receiving circuitry, configured to receive a call request;
a second receiving circuitry, configured to receive a call forwarding request made by a user, where a call forwarding destination number is carried in the call forwarding request; and
a first transmitting circuitry, configured to transmit a response message containing the call forwarding destination number to a network side, so that the network side can forward the call request to a terminal corresponding to the call forwarding destination number according to the response message.

7. The apparatus according to claim 6, wherein the call forwarding destination number comprises a number input by the user or a number corresponding to a contact selected by the user.

8. The apparatus according to claim 6, wherein the response message comprises information indicating forwarding.

9. An apparatus for call forwarding, located in a network side device, comprising:
a third receiving circuitry, configured to receive a response message containing a call forwarding destination number; and
a forwarding circuitry, configured to forward a call request to a terminal corresponding to the call forwarding destination number according to the response message.

10. The apparatus according to claim 9, further comprising: a second transmitting circuitry, configured to transmit a notification message of forwarding the call request to the call forwarding destination number to a calling party terminal, after the third receiving circuitry receives the response message containing the calling forwarding destination number.

11. A terminal, comprising the apparatus for call forwarding according to claim 6.

12. A network side device, comprising the apparatus for call forwarding according to claim 9.
